(19) United States
(12) Patent Application Publication
(10) Pub. No.: US 2007/0228815 A1
(43) Pub. Date: Oct. 4, 2007

(54) Brake force detecting apparatus

(75) Inventors: Takehiro Horiuchi, Saitama (JP); Hiromi Inagaki, Saitama (JP); Takayuki Ohmori, Saitama (JP)

Correspondence Address: CARRIER BLACKMAN AND ASSOCIATES, 24101 NOVI ROAD, SUITE 100, NOVI, MI, 48375, US

(73) Assignee: Honda Motor Co., Ltd., Tokyo (JP)

(21) Appl. No.: 11/717,816

(22) Filed: Mar. 14, 2007

(30) Foreign Application Priority Data
Mar. 30, 2006 (JP) 2006-094581
Sep. 19, 2006 (JP) 2006-252973

(51) Int. Cl. B60T 8/52; B60T 8/00

(52) U.S. Cl. 303/112

(57) ABSTRACT

A brake force detecting apparatus for detecting strain in a caliper bracket. The caliper bracket has two fixed portions fixed to a wheel support and a connecting portion for connecting the fixed portions. The connecting portion of the caliper bracket is formed with a recess at a position radially outside of a line connecting the fixed portions in the radial direction of a brake disc. A sensor plate is press-fitted in the recess of the connecting portion in engaged relationship with the connecting portion so as to undergo deformation generated in the connecting portion in its tensile direction. A strain gauge is attached to the sensor plate.

### BACKGROUND OF THE INVENTION

1. Field of the Invention

The present invention relates to a brake force detecting apparatus for detecting a brake force produced by a disc brake.

2. Description of the Related Art

In the case of performing braking control for a vehicle, a brake force is one of the important items of information. For example, if a brake force actually applied during braking can be detected, the condition of a road surface can be easily estimated. If the condition of a road surface can be estimated, ABS control (antiskid brake system control) can be performed more precisely, and the vehicle can therefore be braked to a halt safely in a short distance. Further, if a brake force applied to each wheel can be detected in braking during turning of the vehicle or during running on a slippery road surface having a low coefficient of friction (i), the brake forces for all the wheels can be individually controlled to thereby allow safer running control of the vehicle.

Conventionally developed is a disc brake such that a load cell is provided on a supporting and engaging portion of a support member for friction pads or a stain gauge is attached to the supporting and engaging portion to thereby detect a brake force. However, the portion near the friction pads easily becomes hot because of heat generated by the friction between each friction pad and a brake disc. Accordingly, the load cell or stain gauge having a present performance is not suitable as an on-vehicle component in consideration of heat resistance, environmental resistance, service life, etc. In this respect, a brake force measuring apparatus unsusceptible to heat has been proposed in Japanese Patent Laid-open No. Hei 6-123665. The brake force measuring apparatus disclosed in this publication includes a support member interposed between a brake caliper and a knuckle arm and having a pair of substantially perpendicular beams and also includes detecting means for detecting displacement of the beams.

According to the brake force measuring apparatus described in Japanese Patent Laid-open No. Hei 6-123665, the measuring apparatus has such an advantage that it is unsusceptible to heat. However, the brake force measuring apparatus has an H-shaped cross section, so that the distance between a caliper bracket and a knuckle in the axial direction of the brake disc is large, causing an increase in size of the measuring apparatus. Further, it is difficult to arrange a displacement detecting apparatus between the two beams. Further, in the brake force measuring apparatus described in Japanese Patent Laid-open No. Hei 6-123665, deformation due to the brake force in braking during forward running of the vehicle and deformation due to the brake force in braking during reverse running of the vehicle are generated in opposite directions. Accordingly, strain is generated both in a tensile direction and in a compressive direction, so that the zero point calibration for a sensor output is difficult, causing a problem on stabilization of a detection output.

### SUMMARY OF THE INVENTION

It is therefore an object of the present invention to provide a brake force detecting apparatus which can facilitate the zero point calibration for a sensor output to thereby stabilize a detection output.

In accordance with a first aspect of the present invention, there is provided a brake force detecting apparatus for a braking apparatus including a wheel support for rotatably supporting a wheel, the wheel support being supported to a vehicle body by a suspension, a brake disc rotating with the wheel, a pair of friction pads provided on both sides of the brake disc, a brake caliper containing a pressure member for pressing the friction pads against the brake disc, the pressure member being moved toward and away from the brake disc in a direction parallel to the axis of the brake disc, and a caliper bracket for supporting the friction pads at a disc inlet position and a disc outlet position thereof in the rotational direction of the brake disc and also supporting the brake caliper, the caliper bracket being fixed to the wheel support; the caliper bracket having at least two fixed portions fixed to the wheel support and a connecting portion for connecting the fixed portions; the brake force detecting apparatus including a sensor plate for undergoing deformation generated in the connecting portion in a tensile direction thereof, the sensor plate being mounted on the connecting portion at a position radially outside of a line connecting the at least two fixed portions in the radial direction of the brake disc; and strain detecting means mounted on the sensor plate.

With this arrangement, the sensor plate is mounted on the connecting portion so as to undergo deformation generated in the connecting portion in the tensile direction. Accordingly, deformation of the sensor plate by the brake force is generated in only the tensile direction during both the forward running and the reverse running of the vehicle. As a result, the zero point calibration for a sensor output can be easily performed to thereby stabilize a detection output. Further, the brake force is detected at a position where larger strain is generated, so that the detection accuracy can be improved.

In accordance with a second aspect of the present invention, there is provided a brake force detecting apparatus for a braking apparatus including a wheel support for rotatably supporting a wheel, the wheel support being supported to a vehicle body by a suspension, a brake disc rotating with the wheel, a pair of friction pads provided on both sides of the brake disc, a brake caliper containing a pressure member for pressing the friction pads against the brake disc, the pressure member being moved toward and away from the brake disc in a direction parallel to the axis of the brake disc, and a caliper bracket for supporting the friction pads at a disc inlet position and a disc outlet position thereof in the rotational direction of the brake disc and also supporting the brake caliper, the caliper bracket being fixed to the wheel support; the caliper bracket having at least two fixed portions fixed to the wheel support and a connecting portion for connecting the fixed portions; the brake force detecting apparatus including a sensor plate for undergoing deformation generated in the connecting portion in a compressive direction thereof, the sensor plate being mounted on the connecting portion at a position radially inside of a line connecting the at least two fixed portions in the radial direction of the brake disc; and strain detecting means mounted on the sensor plate.

With this arrangement, the sensor plate is mounted on the connecting portion so as to undergo deformation generated in the connecting portion in the compressive direction. Accordingly, deformation of the sensor plate by the brake force is generated in only the compressive direction during both the forward running and the reverse running of the vehicle. As a result, the zero point calibration for a sensor output can be easily performed to thereby stabilize a detection output. Further, the brake force is detected at a position where larger strain is generated, so that the detection accuracy can be improved.

In the first aspect mentioned above, it is preferable that the connecting portion of the caliper bracket is formed with a recess extending over the thickness of the connecting portion in the axial direction of the brake disc at a position radially outside of the line connecting the at least two fixed portions in the radial direction of the brake disc, and the sensor plate is inserted in the recess in the axial direction of the brake disc.

Accordingly, a preassembled sensor unit including the sensor plate and the strain detecting means can be simply press-fitted into the recess, thus improving the manufacturability and assemblability. Accordingly, this configuration is suitable for mass production.

In the first aspect mentioned above, it is preferable that the sensor plate is fixed to the radially outside surface of the connecting portion in the radial direction of the brake disc at at least two positions spaced apart from each other in the longitudinal direction of the connecting portion.

With this arrangement, the sensor plate is fixed to the radially outside surface of the connecting portion in the radial direction of the brake disc at at least two positions spaced apart from each other in the longitudinal direction of the connecting portion. Accordingly, the sensor plate can be easily fixed.

In the second aspect mentioned above, it is preferable that the connecting portion of the caliper bracket is formed with a recess extending over the thickness of the connecting portion in the axial direction of the brake disc at a position radially inside of the line connecting the at least two fixed portions in the radial direction of the brake disc; and the sensor plate is inserted in the recess in the axial direction of the brake disc.

Accordingly, a preassembled sensor unit including the sensor plate and the strain detecting means can be simply press-fitted into the recess, thus improving the manufacturability and assemblability. Accordingly, this configuration is suitable for mass production.

In the second aspect mentioned above, it is preferable that the sensor plate is fixed to the radially inside surface of the connecting portion in the radial direction of the brake disc at at least two positions spaced apart from each other in the longitudinal direction of the connecting portion. Accordingly, the sensor plate can be easily fixed.

In both the first and second aspects mentioned above, it is preferable that the sensor plate is engaged with the recess so as to be prevented from being removed in the radial direction of the brake disc.

Accordingly, even if large deformation is generated in the connecting portion, the removal of the sensor plate in the radial direction of the brake disk can be prevented, and the sensor plate can be stably retained to the connecting portion.

The above and other objects, features and advantages of the present invention and the manner of realizing them will become more apparent, and the invention itself will best be understood from a study of the following description and appended claims with reference to the attached drawings showing some preferred embodiments of the invention.

### BRIEF DESCRIPTION OF THE DRAWINGS

FIG. 1 is a perspective view of a disk brake including a brake force detecting apparatus according to a first preferred embodiment of the present invention;

FIG. 2 is a left side view of the disc brake shown in FIG. 1;

FIG. 3 is a schematic sectional view of the disc brake;

FIG. 4 is a side view showing an essential part of the brake force detecting apparatus according to the first preferred embodiment;

FIG. 5 is a side view showing an essential part of a brake force detecting apparatus according to a second preferred embodiment of the present invention;

FIG. 6 is a side view showing an essential part of a brake force detecting apparatus according to a third preferred embodiment of the present invention;

FIG. 7 is a cross section taken along the line 7-7 in FIG. 6;

FIG. 8 is a plan view of FIG. 6;

FIG. 9 is a side view showing an essential part of a brake force detecting apparatus according to a fourth preferred embodiment of the present invention; and

FIG. 10 is a graph showing the relation between brake torque and strain gauge output in the brake force detecting apparatus according to the present invention.

### DETAILED DESCRIPTION OF THE PREFERRED EMBODIMENTS

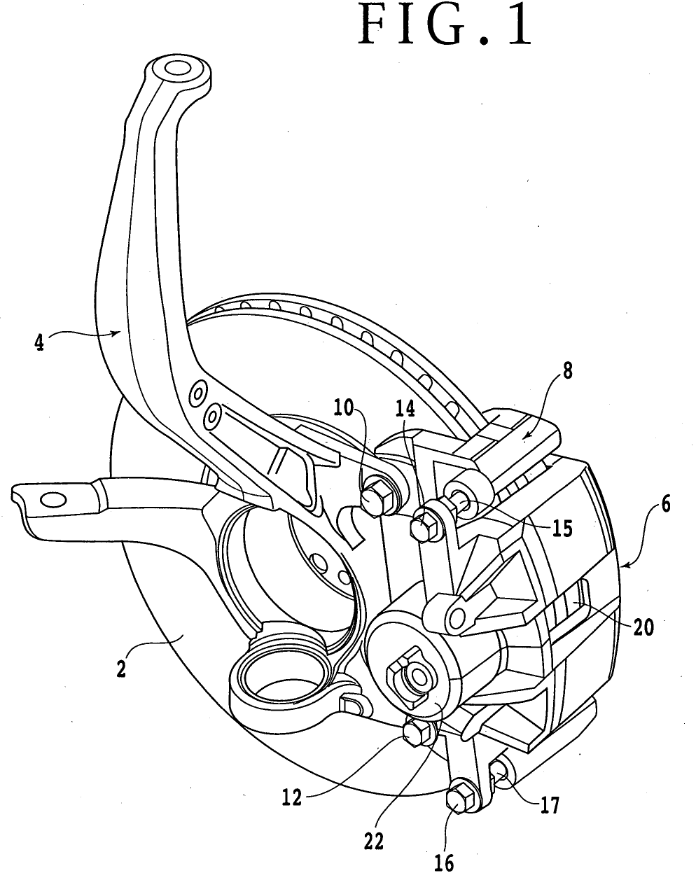

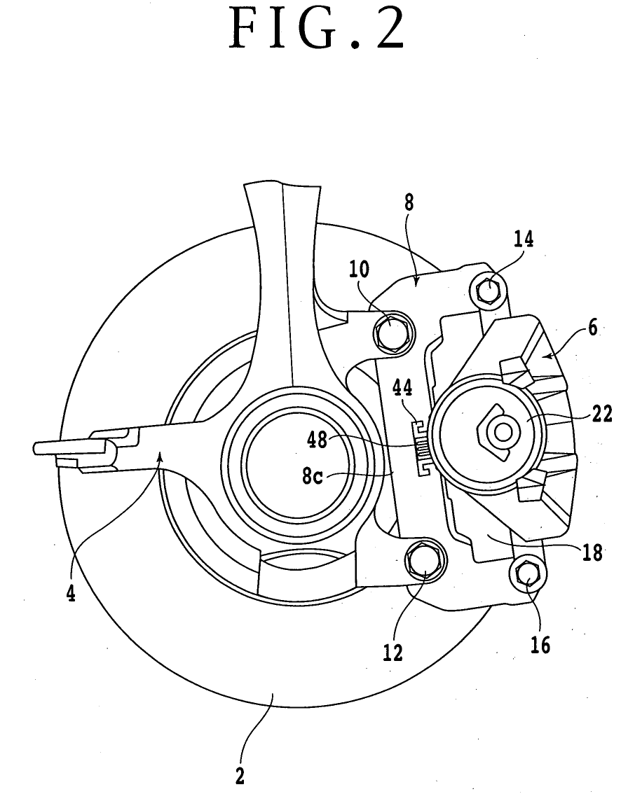

Some preferred embodiments of the present invention will now be described in detail with reference to the drawings. FIG. 1 is a perspective view of a disc brake including a brake force detecting apparatus according to a first preferred embodiment of the present invention. FIG. 2 is a left side view of the disc brake shown in FIG. 1. As shown in FIGS. 1 and 2, a brake disc (disc rotor) 2 is fixed to a wheel (not shown), so that the brake disc 2 is rotated with the wheel. Reference numeral 4 denotes a knuckle (wheel support) for rotatably supporting the wheel. The knuckle 4 is connected through a suspension (not shown) to a vehicle body (not shown).

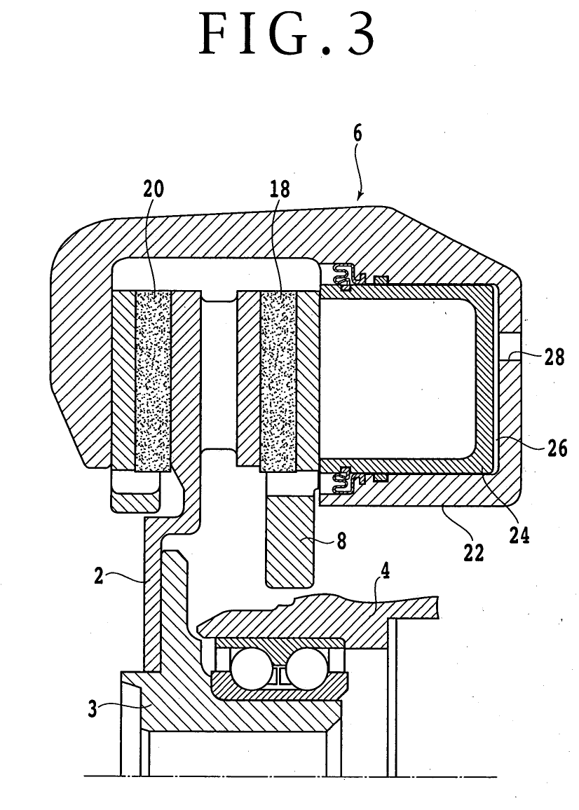

Reference numeral 8 denotes a caliper bracket, which is mounted to the knuckle 4 by two bolts 10 and 12. The caliper bracket 8 supports a pair of friction pads 18.and 20 at two opposite positions in the rotational direction of the brake disc 2, i.e., at a disc inlet position and a disc outlet position in the rotational direction of the brake disc 2. The friction pads 18 and 20 are provided on the axially opposite sides of the brake disc 2. Two slide pins 15 and 17 are slidably engaged with the caliper bracket 8. The slide pins 15 and 17 are fixed to a brake caliper 6 by two bolts 14 and 16, respectively. As shown in FIG. 3, the brake caliper 6 contains a piston (pressure member) 24 adapted to be moved toward and away from the brake disc 2 in the axial direction thereof, thereby pressing the friction pads 18 and 20 against the brake disc 2.

The brake caliper 6 has an integral wheel cylinder 22, and the piston 24 is engaged in the wheel cylinder 22. A piston chamber 26 is defined between the wheel cylinder 22 and the piston 24, and a fluid pressure is supplied from a brake master cylinder (not shown) through a pressure supply port 28 into the piston chamber 26. The brake disc 2 is connected to a hub 3. When a fluid pressure is supplied from the brake master cylinder through the pressure supply port 28 into the piston chamber 26, the piston 24 is pushed leftward as viewed in FIG. 3, so that the friction pad 18 is pressed on the brake disc 2. At the same time, the brake caliper 6 is moved rightward by a reaction force resulting from the pressure of the piston 24 applied through the friction pad 18 to the brake disc 2. As a result, the friction pad 20 is pressed on the brake disc 2, thereby braking the rotation of the brake disc 2.

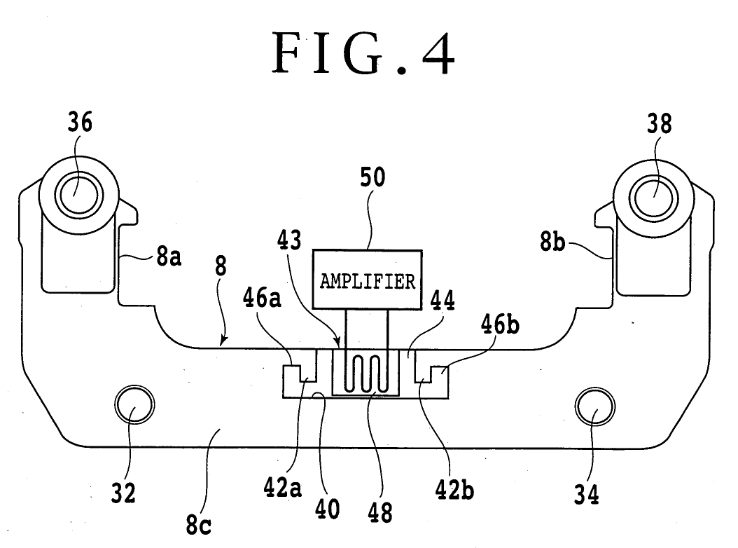

Referring to FIG. 4, there is shown an essential part of the brake force detecting apparatus according to the first preferred embodiment of the present invention. The caliper bracket 8 has two tapped holes 32 and 34 for threaded engagement with the respective bolts 10 and 12, and further has two engaging holes 36 and 38 for slidable engagement with the respective slide pins 15 and 17. The caliper bracket 8 has a substantially U-shaped configuration such that it is composed of a pair of brake load receiving portions 8a and 8b, an inner connecting portion (inner bridge portion) 8c for connecting the brake load receiving portions 8a and 8b, and an outer connecting portion (outer bridge portion) (not shown) extending in parallel to the inner connecting portion 8c. The caliper bracket 8 is substantially symmetrical with respect to the line connecting the center of rotation of the brake disc 2 and the center of the piston 24.

The inner connecting portion 8c extends between the two tapped holes 32 and 34. The inner connecting portion 8c is formed with a recess 40 extending over the thickness of the inner connecting portion 8c in the axial direction of the brake disc 2 at a position radially outside of the line connecting the two tapped holes 32 and 34 in the radial direction of the brake disc 2. The recess 40 is so formed as to leave a pair of engaging projections 42a and 42b in the inner connecting portion 8c of the caliper bracket 8. A sensor unit 43 is press-fitted in the recess 40 in the axial direction of the brake disc 2. The sensor unit 43 is composed of a sensor plate 44 having a pair of engaging projections 46a and 46b respectively closely engaged with the engaging projections 42a and 42b of the caliper bracket 8, a strain gauge 48 attached to the sensor plate 44, and an amplifier 50 for amplifying an output from the strain gauge 48.

In the case of braking during forward running of the vehicle, the friction pads 18 and 20 come into pressure contact with the brake disc 2 during rotation of the brake disc 2, so that the friction pads 18 and 20 are dragged by the brake disc 2 to move in the rotational direction of the brake disc 2. As a result, the friction pads 18 and 20 abut against the brake load receiving portion 8b of the caliper bracket 8, and a tensile load is accordingly generated in a radially outside portion of the inner connecting portion 8c in the radial direction of the brake disc 2. Owing to this tensile load, the engaging projections 46a and 46b of the sensor plate 44 are pulled by the engaging projections 42a and 42b of the inner connecting portion 8c, so that deformation is produced in the sensor plate 44 in its tensile direction.

This deformation is detected by the strain gauge 48, and an output from the strain gauge 48 is amplified by the amplifier 50 connected to the strain gauge 48, thereby detecting the brake force according to the amount of strain in the sensor plate 44. The strain in the sensor plate 44 is generated only when the brake torque is transmitted through the brake load receiving portion 8b and the inner connecting portion 8c of the caliper bracket 8. Accordingly, the strain in the sensor plate 44 is hardly influenced by a vertical force and a lateral force, so that the brake force can be detected accurately.

In the case of braking during reverse running of the vehicle, the brake disc 2 is rotated in a reverse direction opposite to the rotational direction during forward running of the vehicle, so that the friction pads 18 and 20 are dragged by the brake disc 2 to move in the reverse direction of the brake disc 2 and to abut against the brake load receiving portion 8a of the caliper bracket 8. Accordingly, also during the reverse running, a tensile load is generated in the radially outside portion of the inner connecting portion 8c present radially outside of the line connecting the tapped holes 32 and 34 in the radial direction of the brake disc 2. Owing to this tensile load, the sensor plate 44 is subjected to deformation in its tensile direction, and this deformation is detected by the strain gauge 48. Thus, according to this preferred embodiment, the deformation of the sensor plate 44 by the brake force is produced in the tensile direction thereof during both the forward running and the reverse running of the vehicle. As a result, the zero point calibration for a sensor output can be easily performed to thereby stabilize a detection output.

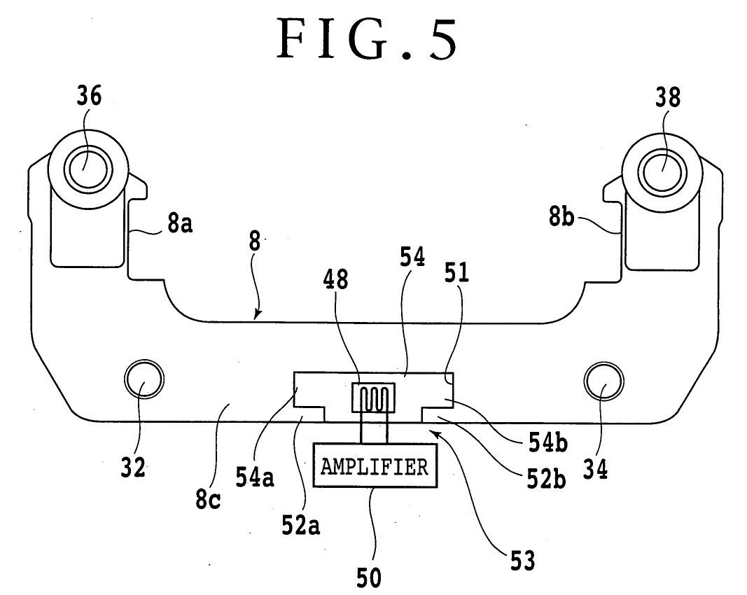

FIG. 5 shows an essential part of a brake force detecting apparatus according to a second preferred embodiment of the present invention. In this preferred embodiment, a recess 51 is formed at a radially inside portion of the inner connecting portion 8c present radially inside of the line connecting the tapped holes 32 and 34 in the radial direction of the brake disc 2, and a sensor unit 53 is press-fitted in the recess 51 in the axial direction of the brake disc 2. As in the first preferred embodiment, the sensor unit 53 is composed of a sensor plate 54 press-fitted in the recess 51, a strain gauge 48 attached to the sensor plate 54, and an amplifier 50 connected to the strain gauge 48.

The recess 51 is so formed as to leave a pair of engaging projections 52a and 52b in the inner connecting portion 8c. Accordingly, when the sensor plate 54 is press-fitted into the recess 51, a pair of engaging projections 54a and 54b of the sensor plate 54 come into engagement with the engaging projections 52a and 52b of the inner connecting portion 8c, thereby preventing the removal of the sensor plate 54 in the radial direction of the brake disc 2. In this preferred embodiment, the sensor unit 53 is press-fitted in the recess 51 formed radially inside of the line connecting the tapped holes 32 and 34 in the radial direction of the brake disc 2. Accordingly, in the case of braking during both the forward running and the reverse running of the vehicle, the sensor plate 54 is subjected to deformation in its compressive direction. As a result, the zero point calibration for a sensor output can be easily performed to thereby stabilize a detection output as in the first preferred embodiment.

In the first and second preferred embodiments, the stain gauge 48 may be attached to the inner connecting portion 8c of the caliper bracket 8 rather than press-fitting the sensor plate 44 or 54 into the recess 40 or 51. In this case, the strain gauge 48 can be subjected to deformation in its tensile direction or in its compressive direction. However, since the strain gauge 48 must be directly attached to the caliper bracket 8 as a component having a complex shape, the manufacturability of the brake force detecting apparatus becomes low.

The first and second preferred embodiments of the present invention have been developed in consideration of the manufacturability and assemblability. That is, the recess 40 or 51 is preliminarily formed in the caliper bracket 8, and the preassembled sensor unit 43 or 53 is simply press-fitted into the recess 40 or 51 of the caliper bracket 8, thereby completing the brake force detecting apparatus. Thus, the manufacturability and assemblability of the brake force detecting apparatus according to the first and second preferred embodiments can be improved, and these preferred embodiments are suitable for mass production. As a modification, any strain detecting means other than the strain gauge 48 may be mounted on the sensor plate 44 or 54.

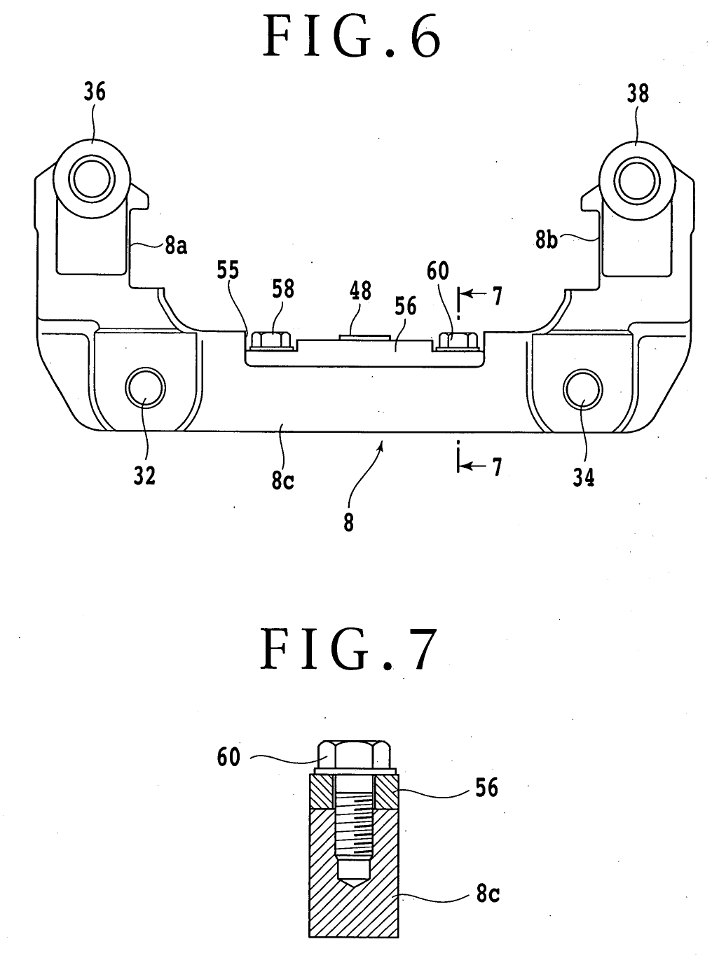

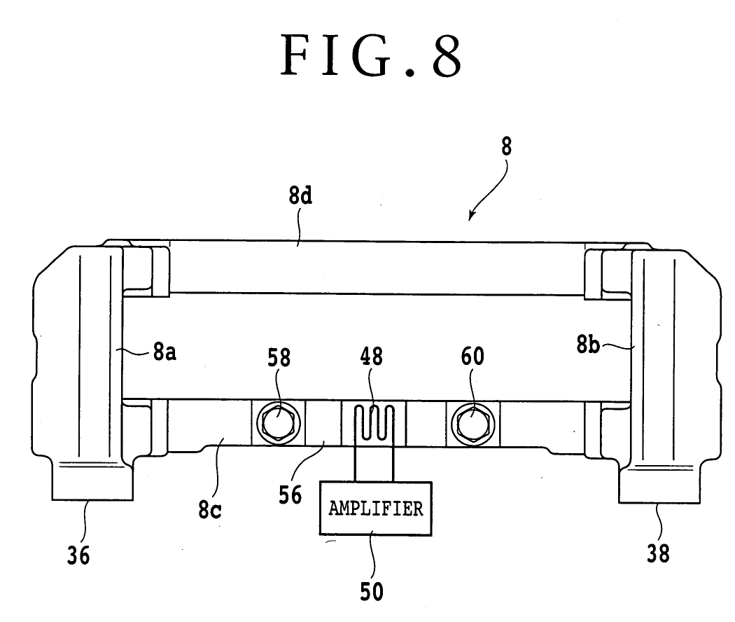

FIG. 6 shows an essential part of a brake force detecting apparatus according to a third preferred embodiment of the present invention. FIG. 7 is a cross section taken along the line 7-7 in FIG. 6, and FIG. 8 is a plan view of FIG. 6. As apparent from FIG. 8, the caliper bracket 8 is composed of a pair of brake load receiving portions 8a and 8b, an inner connecting portion (inner bridge portion) 8c for connecting the brake load receiving portions 8a and 8b, and an outer connecting portion (outer bridge portion) 8d extending in parallel to the inner connecting portion 8c. A recess 55 is formed on the radially outside surface of the inner connecting portion 8c of the caliper bracket 8 in the radial direction of the brake disc 2. A sensor plate 56 is fixed in the recess 55 by means of a pair of bolts 58 and 60 spaced apart from each other in the longitudinal direction of the inner connecting portion 8c. As shown in FIG. 8, a strain gauge 48 is attached to the sensor plate 56. The strain gauge 48 is connected to an amplifier 50 for amplifying an output from the strain gauge 48.

In the case of braking during forward running of the vehicle, the friction pads 18 and 20 come into pressure contact with the brake disc 2 during rotation of the brake disc 2, so that the friction pads 18 and 20 are dragged by the brake disc 2 to move in the rotational direction of the brake disc 2. As a result, the friction pads 18 and 20 abut against the brake load receiving portion 8b of the caliper bracket 8. The caliper bracket 8 is fixed to the knuckle 4 by respectively engaging the bolts 10 and 12 into the tapped holes 32 and 34. Accordingly, a tensile load is generated in the sensor plate 56 fixed to the radially outside surface of the inner connecting portion 8c in the radial direction of the brake disc 2. Owing to this tensile load, deformation is produced in the sensor plate 56 in its tensile direction.

This deformation is detected by the strain gauge 48, and an output from the strain gauge 48 is amplified by the amplifier 50 connected to the strain gauge 48, thereby detecting the brake force according to the amount of strain in the sensor plate 56. The stain in the sensor plate 56 is generated only when the brake torque is transmitted through the brake load receiving portion 8b and the inner connecting portion 8c of the caliper bracket 8. Accordingly, the strain in the sensor plate 56 is hardly influenced by a vertical force and a lateral force, so that the brake force can be detected accurately.

In the case of braking during reverse running of the vehicle, the brake disc 2 is rotated in a reverse direction opposite to the rotational direction during forward running of the vehicle, so, that the friction pads 18 and 20 are dragged by the brake disc 2 to move in the reverse direction of the brake disc 2 and to abut against the brake load receiving portion 8a of the caliper bracket 8. Accordingly, also during the reverse running, a tensile load is generated in the radially outside portion of the inner connecting portion 8c present radially outside of the line connecting the tapped holes 32 and 34 in the radial direction of the brake disc 2. Owing to this tensile load, the sensor plate 56 is subjected to deformation in its tensile direction, and this deformation is detected by the strain gauge 48. Thus, according to this preferred embodiment, the deformation of the sensor plate 56 by the brake force is produced in the tensile direction thereof during both the forward running and the reverse running of the vehicle as in the first preferred embodiment. As a result, the zero point calibration for a sensor output can be easily performed to thereby stabilize a detection output.

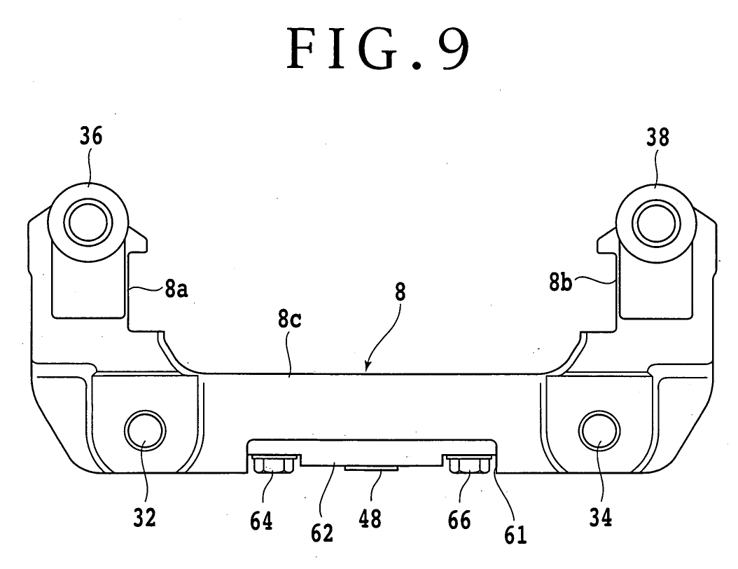

FIG. 9 shows an essential part of a brake force detecting apparatus according to a fourth preferred embodiment of the present invention. In this preferred embodiment, a recess 61 is formed on the radially inside surface of the inner connecting portion 8c of the caliper bracket 8 in the radial direction of the brake disc 2. A sensor plate 62 is fixed in the recess 61 by means of a pair of bolts 64 and 66 spaced apart from each other in the longitudinal direction of the inner connecting portion 8c. As in the third preferred embodiment shown in FIG. 8, a strain gauge 48 is attached to the sensor plate 62, and the strain gauge 48 is connected to an amplifier 50. In this preferred embodiment, the sensor plate 62 is fixed to the radially inside surface of the inner connecting portion 8c present radially inside of the line connecting the tapped holes 32 and 34 in the radial direction of the brake disc 2. Accordingly, in the case of braking during both the forward running and the reverse running of the vehicle, the sensor plate 62 is subjected to deformation in its compressive direction. As a result, the zero point calibration for a sensor output can be easily performed to thereby stabilize a detection output as in the first to third preferred embodiments.

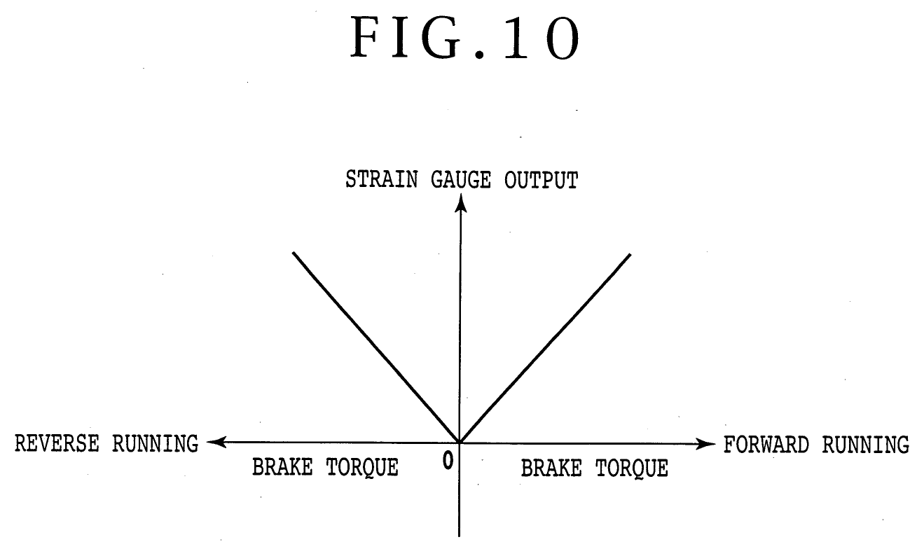

In the first and third preferred embodiments, strain is generated in the strain gauge 48 in only the tensile direction when a brake force is applied to the brake disc 2 during both the forward running and the reverse running of the vehicle. In the second and fourth preferred embodiments, strain is generated in the strain gauge 48 in only the compressive direction when a brake force is applied to the brake disc 2 during both the forward running and the reverse running of the vehicle. Accordingly, in the brake force detecting apparatus according to the present invention, the output from the strain gauge 48 in the case of braking during the reverse running is symmetrical with the output from the strain gauge 48 in the case of braking during the forward running with respect to the vertical axis as shown in FIG. 10. Accordingly, as compared with the case that a strain gauge is subjected to deformation in its tensile direction during the forward running and subjected to deformation in its compressive direction during the reverse running, the resolution of the strain gauge 48 can be nearly doubled.

The present invention is not limited to the details of the above described preferred embodiments. The scope of the invention is defined by the appended claims and all changes and modifications as fall within the equivalence of the scope of the claims are therefore to be embraced by the invention.

What is claimed is:

1. A brake force detecting apparatus for a braking apparatus including a wheel support for rotatably supporting a wheel, said wheel support being supported to a vehicle body by a suspension, a brake disc rotating with said wheel, a pair of friction pads provided on both sides of said brake disc, a brake caliper containing a pressure member for pressing said friction pads against said brake disc, said pressure member being moved toward and away from said brake disc in a direction parallel to the axis of said brake disc, and a caliper bracket for supporting said friction pads at a disc inlet position and a disc outlet position thereof in the rotational direction of said brake disc and also supporting said brake caliper, said caliper bracket being fixed to said wheel support;
said caliper bracket having at least two fixed portions fixed to said wheel support and a connecting portion for connecting said fixed portions;
said brake force detecting apparatus comprising:
a sensor plate for undergoing deformation generated in said connecting portion in a tensile direction thereof, said sensor plate being mounted on said connecting portion at a position radially outside of a line connecting said at least two fixed portions in the radial direction of said brake disc; and
strain detecting means mounted on said sensor plate.

2. A brake force detecting apparatus for a braking apparatus including a wheel support for rotatably supporting a wheel, said wheel support being supported to a vehicle body by a suspension, a brake disc rotating with said wheel, a pair of friction pads provided on both sides of said brake disc, a brake caliper containing a pressure member for pressing said friction pads against said brake disc, said pressure member being moved toward and away from said brake disc in a direction parallel to the axis of said brake disc, and a caliper bracket for supporting said friction pads at a disc inlet position and a disc outlet position thereof in the rotational direction of said brake disc and also supporting said brake caliper, said caliper bracket being fixed to said wheel support;
said caliper bracket having at least two fixed portions fixed to said wheel support and a connecting portion for connecting said fixed portions;
said brake force detecting apparatus comprising:
a sensor plate for undergoing deformation generated in said connecting portion in a compressive direction thereof, said sensor plate being mounted on said connecting portion at a position radially inside of a line connecting said at least two fixed portions in the radial direction of said brake disc; and
strain detecting means mounted on said sensor plate.

3. The brake force detecting apparatus according to claim 1, wherein said connecting portion of said caliper bracket is formed with a recess extending over the thickness of said connecting portion in the axial direction of said brake disc at a position radially outside of the line connecting said at least two fixed portions in the radial direction of said brake disc; and
said sensor plate is inserted in said recess in the axial direction of said brake disc.

4. The brake force detecting apparatus according to claim 1, wherein said sensor plate is fixed to the radially outside surface of said connecting portion in the radial direction of said brake disc at at least two positions spaced apart from each other in the longitudinal direction of said connecting portion.

5. The brake force detecting apparatus according to claim 2, wherein said connecting portion of said caliper bracket is formed with a recess extending over the thickness of said connecting portion in the axial direction of said brake disc at a position radially inside of the line connecting said at least two fixed portions in the radial direction of said brake disc; and
said sensor plate is inserted in said recess in the axial direction of said brake disc.

6. The brake force detecting apparatus according to claim 2, wherein said sensor plate is fixed to the radially inside surface of said connecting portion in the radial direction of said brake disc at at least two positions spaced apart from each other in the longitudinal direction of said connecting portion.

7. The brake force detecting apparatus according to claim 3, wherein said sensor plate is engaged with said recess so as to be prevented from being removed in the radial direction of said brake disc.

8. The brake force detecting apparatus according to claim 5, wherein said sensor plate is engaged with said recess so as to be prevented from being removed in the radial direction of said brake disc.

9. The brake force detecting apparatus according to claim 4, wherein said sensor plate is fixed at said at least two positions by means of bolts each having an axis perpendicular to the line connecting said at least two fixed portions and parallel to the disc surface of said brake disc.

10. The brake force detecting apparatus according to claim 6, wherein said sensor plate is fixed at said at least two positions by means of bolts each having an axis perpendicular to the line connecting said at least two fixed portions and parallel to the disc surface of said brake disc.
